(19) United States
(12) Patent Application Publication
(10) Pub. No.: US 2012/0288601 A1
(43) Pub. Date: Nov. 15, 2012

(54) COCONUT TOOL

(76) Inventor: Hugh Wegwerth, Falcon Heights, MN (US)

(21) Appl. No.: 13/457,818

(22) Filed: Apr. 27, 2012

Related U.S. Application Data
(60) Provisional application No. 61/484,777, filed on May 11, 2011.

(51) Int. Cl. A47J 17/00; B26B 1/02; A23L 1/212

(52) U.S. Cl. 426/482; 99/568; 99/571

(57) ABSTRACT

A coconut tool for extracting meat from a coconut shell comprising a beveled handle constructed from a non-conducting material such as wood or plastic, a concave shaped knife blade with a sharp end constructed of high quality, heavy, pliable stainless steel or other sturdy metal, capable of removing the meat in one piece from the shell of a coconut in a matter of 60 to 90 seconds.

### CROSS REFERENCE TO RELATED APPLICATION

This application claims priority to U.S. Provisional Patent Application No. 61/484,777 filed May 11, 2011.

### FIELD OF THE INVENTION

The present invention relates generally to knives and similar tools for extracting the fleshy, edible, parts of a nut, fruit or vegetable. More particularly, the invention relates to coconut meat extracting knives and tools.

### BACKGROUND OF THE INVENTION

Knives for cutting and chopping food, paring and coring knives specially designed to extract the flesh of fruits such as grapefruits, oranges, and vegetables such as tomatoes, pitting seeds from fruits such as peaches and grapefruit are all well known in the art. Tools for extracting the meaty flesh from nuts such as walnuts, pecans and other nuts are also known in the art. Most of these nuts have soft shells which can be cracked open easily and their meat extracted using a knife or simple tool even with a blunt end.

Unlike other nuts, the coconut has a large, nearly spherical, and very hard shell that is difficult to crack open using simple instruments. Tools to pierce the hard shell of a coconut such as described in U.S. Pat. No. 7,959,967 (Pattenden), a coconut opener to pierce the shell to withdraw the coconut water inside the shell as described in U.S. Pat. No. 5,119,559 (Sanabria), and a coconut opener with a corkscrew assembly as in U.S. Pat. Appl. No. 2011/036249 (Sheldon) are known in the prior art. However, once the coconut shell is cracked, extracting the meat inside the shell is a particularly imposing task because unlike in a walnut or pecan where the meaty flesh is loosely attached to the inside of the nut shell, in a coconut, the meaty flesh is tightly attached to the inside layer of the shell and therefore hard to pry out with an ordinary knife with a straight blade. The hemispherical shape of one half of the coconut shell when it is cracked open poses a particular challenge for a straight blade knife in its ability to get in between the meat and the curved shell without the knife blade having some degree of curvature. Knives with curved blades such as those used to extract the edible flesh of grapefruit and oranges are too fragile and not up to the challenge of coconut meat extraction.

Coconut graters and coconut meat scrapers have been used for ages and are still in use in different cultures around the world to extract the coconut meat from inside the coconut shell. However, these tools are generally bulky and difficult to handle and the grating and scraping of the coconut meat from the shell, a messy process.

The increasing popularity of the coconut for its flavorful water, meaty flesh with its high fiber content, the coconut milk extracted from the meat, and to a lesser extent the use of coconut oil, in the western world has necessitated the need for compact, yet, strong and efficient tools to extract the coconut meat from its hard shell for consumption.

The present invention overcomes the deficiencies in the prior art for a coconut meat extracting knife or tool. The Coconut meat extracting tool of the present invention is an ergonomically shaped instrument with a sturdy handle and a strong, flexible, concave blade capable of withstanding the force required to get in between the tightly attached coconut meat flesh and the inside of the spherical shell to pry out the meat from the shell in one piece within a matter of seconds.

### SUMMARY OF THE INVENTION

The primary object of the present invention is to provide a sturdy, coconut meat extracting tool, that is capable of removing the edible meat inside a coconut shell.

Yet another object of the present invention is to provide a tool that can extract the meat from inside the coconut shell in one piece within a matter of seconds.

In the exemplary embodiment of the present invention, the coconut tool has a handle constructed from a non-conducting material such as wood or plastic, preferably, ironbark timber or similar wood. In this exemplary embodiment of the invention, the blade of the coconut tool is concave shaped and honed from heavy, pliable, stainless steel or other similar sturdy metal. In this embodiment of the invention, the blade of the coconut tool is capable of sliding between the hard inside spherical shaped shell of the coconut and the coconut meat and effortlessly removing the entire meat in one piece within a matter of 60 to 90 seconds.

It is yet another object of the present invention to provide a coconut tool that is also capable of de-husking the coconut to remove the coconut from its outer husk.

Yet, another object of the present invention is to provide a coconut tool with a sturdy handle that can with sufficient force be used to crack open a coconut shell enough to let the water inside the coconut run out and be collected for consumption.

The features and embodiments of the present invention as described in this summary of the invention will be further appreciated and will become obvious to one skilled in the art when viewed in conjunction with the accompanying drawings, detailed description of the invention, and the appended claims.

### BRIEF DESCRIPTION OF THE DRAWINGS

FIG. 1 is a perspective view of the exemplary embodiment of the coconut tool of the present invention.

FIG. 2 is a side view of the exemplary embodiment of the coconut tool of the present invention illustrating the concave shape of the knife blade of the tool.

FIG. 3 is a perspective view of the coconut tool in use when extracting the coconut meat from the coconut shell.

FIG. 4 is another perspective view of the coconut tool in use when extracting the coconut meat from the coconut shell.

### DETAILED DESCRIPTION OF THE INVENTION

The present invention is a coconut tool for extracting meat from the inside of a coconut in a safe and expeditious manner. The sturdy construction of the tool also allows it to be used for de-husking as well as cracking open the coconut shell.

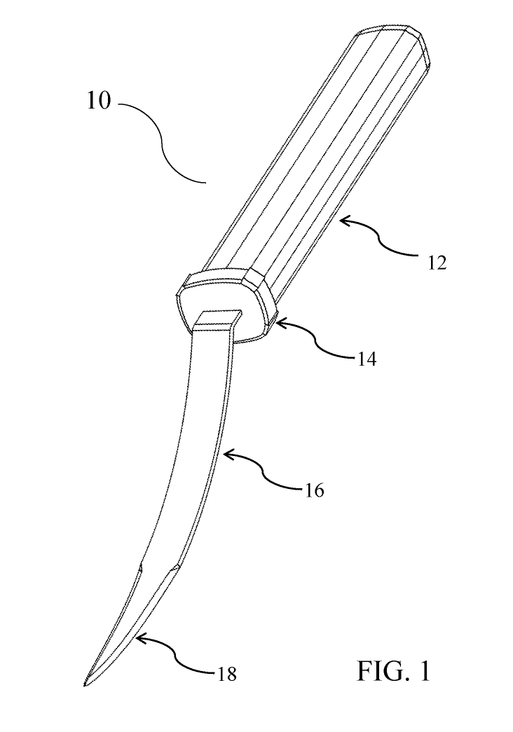

Referring now to the drawings, more particularly to FIG. 1, a perspective view of the exemplary embodiment of the coconut tool 10 is shown. In this embodiment, the handle 12 has a beveled grip and is constructed of a non-conducting material preferably ironbark timber or wood. Alternately, the handle could be constructed of plastic or any material that provides a good grip to the user of the coconut tool 10. The blade 16 of the coconut tool 10 is made of high quality, heavy, pliable, stainless steel that extends all the way into the handle and has a concave shape. Blade 16 is riveted to the handle 12 through a holder 14. The blade 16 has a sharp, pointed end 18 to enable the blade to be inserted between the meat of the coconut and the inside shell. In this embodiment of the invention, the pointed sharp end 18 of the blade 16 is inserted between the coconut meat and the inside shell at an oblique angle so that the tip of the sharp end 18 of the blade 16 is touching the shell beneath the meat kernel. The rest of the blade 16 can then be inserted further in between the meat and the shell and worked around under the meat to dislodge it from the shell while the outside of the coconut shell is rotated with the other hand. This process removes the coconut meat from the shell in one piece within a matter of 60 to 90 seconds.

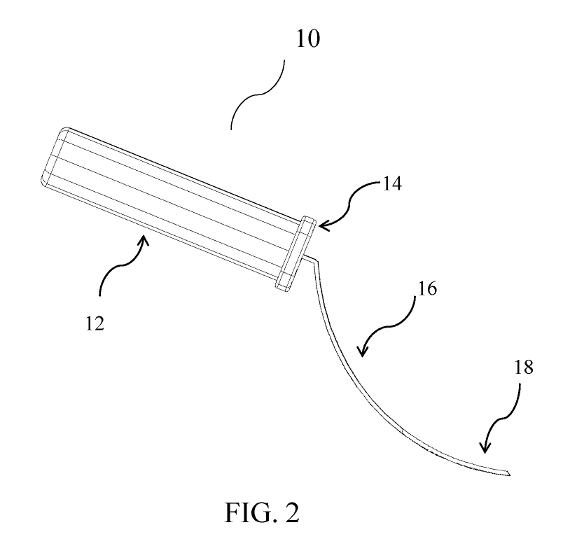

FIG. 2 is a side view of the exemplary embodiment of the coconut tool 10 of the present invention illustrating the concave shape of the knife blade 16 of the tool. The figure shows the beveled handle 12, the holder 14, and the sharp knife end 18.

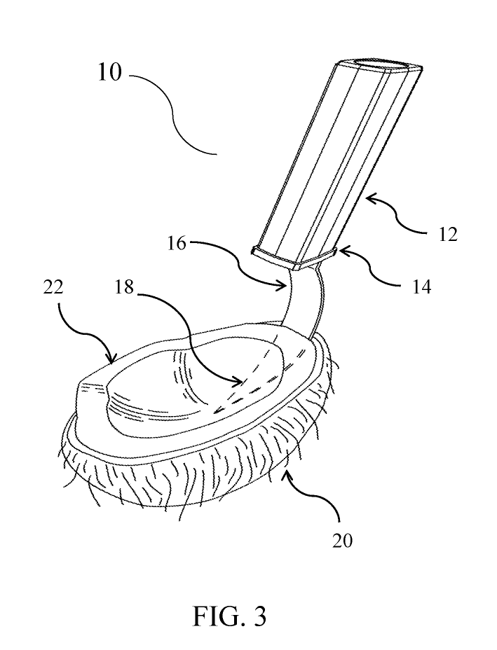

FIG. 3 is a perspective view of the coconut tool 10 in use when extracting the coconut meat 22 from the coconut shell 20. The figure shows the manner in which the sharp knife end 18 of the coconut tool 10 is inserted between the inside of the coconut shell 20 and the bottom layer of the coconut meat 22 before proceeding to work the knife blade 16 under the coconut meat 22 in a concentric manner to lift the coconut meat 22 from the coconut shell 20.

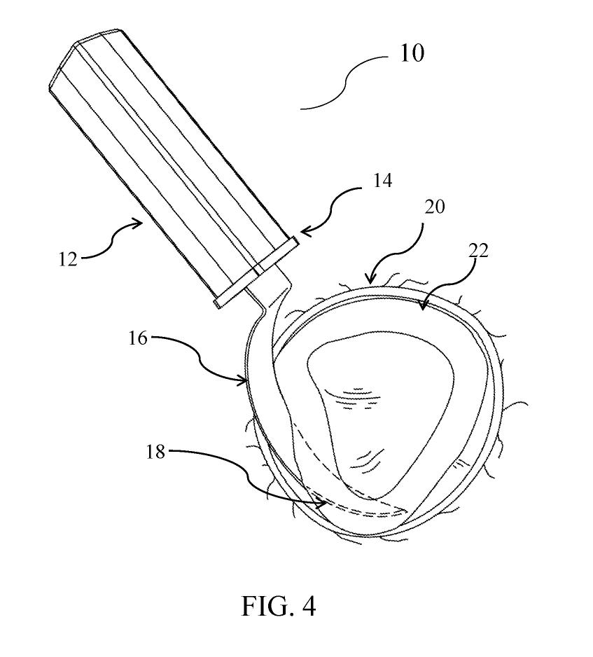

FIG. 4 is another perspective view of the coconut tool 10 in use while extracting the coconut meat 22 from the coconut shell 20. In this view, the separation of the coconut meat 22 from the coconut shell 20 can be more clearly seen as the knife blade 16 and the sharp knife end 18 of the coconut tool 10 is worked concentrically around between the underside of the coconut meat 22 and inside of the coconut shell 20.

In the exemplary embodiment of the coconut tool 10 of the present invention, the length of the handle 12 is approximately 6 ½ inches and the length of the knife blade 16 is 5 ½ inches with an approximate thickness of ⅛ inch.

The exemplary embodiment of the coconut tool 10 of the present invention may also be used for de-husking a coconut using the knife blade 16 and the sharp end 18 and cracking open the coconut, using the handle 12.

It is to be understood that the embodiments of the coconut tool of the present invention as described herein do not limit any application or scope of the invention and that the invention can be carried out and practiced in various ways and implemented in embodiments other than the ones outlined in the description above. It is to be further understood that the phraseology and terminology used to describe the invention are for descriptive purposes only. In general, it should be understood and obvious to one skilled in the art that alternatives, modifications and variations of the embodiments of the invention may be construed as being within the spirit and scope of the appended claims.

What is claimed is:

1. A tool for extracting the meat of a coconut from its shell, the tool comprising:
a beveled handle member;
a concave shaped knife blade member; and
a holder member for hingedly attaching the said beveled handle member to the said concave shaped knife blade member.

2. The tool of claim 1 wherein the concave shaped knife blade member has a sharp end for insertion between the inside coconut shell and the underside of the coconut meat to remove the coconut meat from the shell.

3. The tool of claim 1 wherein the beveled handle member is constructed of a non-conducting material such as ironbark timber, wood, plastic or other sturdy material.

4. The tool of claim 1 wherein the knife blade member is constructed from high quality, heavy, pliable, stainless steel or other sturdy metal.

5. The tool of claim 1 wherein the knife blade member may be used to de-husk the coconut.

6. The tool of claim 1 wherein the handle member may be used to crack the coconut shell.

7. A method of extracting coconut meat from a coconut shell, the method comprising:
holding one half of a coconut in one hand;
holding a coconut tool in the other hand by its beveled handle;
inserting the sharp end of the concave knife blade of the coconut tool between the underside of the coconut meat and the inside shell of a coconut;
rotating the coconut shell with the hand holding the coconut shell;
working the knife blade of the coconut tool under the coconut meat; and
removing the coconut meat in one piece from the coconut shell in a matter of seconds.
